(19) United States
(12) Patent Application Publication
(10) Pub. No.: US 2007/0219644 A1
(43) Pub. Date: Sep. 20, 2007

(54) Information processing apparatus and system state control method

(76) Inventor: Hajime Sonobe, Tachikawa-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/717,890

(22) Filed: Mar. 14, 2007

(30) Foreign Application Priority Data
Mar. 16, 2006 (JP) 2006-072929

(51) Int. Cl. G05B 11/01

(52) U.S. Cl. 700/12

(57) ABSTRACT

According to one embodiment, an information processing apparatus includes a main body, a system memory, a display controller, a temperature sensor, a first state control unit which transitions a system state of the apparatus from a working state to a first state in which the main body is powered off in a state in which power is supplied to the system memory and the display controller, and a second state control unit which transitions the system state from the first state to a second state in which supply of power to the display controller is stopped in a state in which supply of power to the system memory is maintained, in a case where a temperature which is detected by the temperature sensor in the first state exceeds a predetermined threshold value.

### CROSS-REFERENCE TO RELATED APPLICATIONS

This application is based upon and claims the benefit of priority from Japanese Patent Application No. 2006-072929, filed Mar. 16, 2006, the entire contents of which are incorporated herein by reference.

### BACKGROUND

1. Field

One embodiment of the invention relates to an information processing apparatus such as a personal computer, and a system state control method for controlling the system state of the information processing apparatus.

2. Description of the Related Art

In recent years, various types of battery-powerable personal computers have been developed. In these personal computers, power management technology for reducing power consumption has been adopted. A specification called Advanced Configuration and Power Interface (ACPI) is known as an example of the power management technology.

In the ACPI specification, system states S0 to S5 are defined. The system state S0 is a working state (i.e. a state in which the system is powered on and software is being executed), and S5 is an off-state (i.e. a state in which the system is powered off and no software is executed). The system states S1 to S4 are intermediate states between the working state and off-state, that is, sleep states (the context of software immediately before the transition to the sleep state is saved, and the software is halted in the sleep state). The relationship in magnitude of power consumption between these system states is S0>S1>S2>S3>S4>S5.

The personal computer is equipped with a suspend/resume function for realizing both reduction in power consumption and quick restoration to the working state. The suspend/resume function is a function for transitioning the system state of the personal computer from the working state (S0) to a power-saving state such as a standby state, in response to occurrence of a power-off event. As the standby state, one of the sleep states defined in the ACPI specification, for example, system state S3, is used.

In the system state S3, almost all devices excluding the system memory are turned off. In the standby state, that is, in S3, if a wakeup event occurs, the system state is restored from the standby state, i.e. S3, to the working state S0. Thereby, the execution of the software is resumed from the state immediately before the occurrence of the power-off event.

In general, the personal computer is equipped with a temperature control function for suppressing a temperature rise in the system. The temperature control function is a function of monitoring the temperature of the system and executing a predetermined cooling operation, such as rotation of a fan, when the temperature of the system reaches a threshold value.

Jpn. Pat. Appln. KOKAI Publication No. 9-198166 discloses a computer which executes the temperature control function. This computer has a function of setting the system in the standby mode when the temperature that is detected by a thermistor exceeds a predetermined value.

In the meantime, there has recently been a demand for reduction in time that is needed for the restoration from the standby state to the working state.

For example, in the standby state, if not only the system memory but also one or more other specific devices are kept in the power-on state, it becomes possible to quickly restore the system state from the standby state to the working state.

In this case, however, it is possible that the system temperature rises due to the heat from the power-on-state devices even in the state in which the system is in the standby state.

From the viewpoint of users, the standby state is a state in which the computer is completely halted. Thus, the temperature rise in the computer in the standby state may be unpleasant for users.

Normally, the temperature control using a fan or the like is executed only when the computer is in the working state. This temperature control is not executed when the computer is in the standby state. Thus, the heat production by devices in the standby state may excessively raise the temperature in the computer, leading to an operational defect of the system in some cases.

Under the circumstances, there has been a demand for a novel function which enables quick restoration from a power-saving state, such a standby state, to a working state, while keeping a system temperature in the power-saving state at a relatively low level.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view that shows a general appearance of a computer according to an embodiment of the invention;

FIG. 2 is an exemplary block diagram showing an example of the system configuration of the computer shown in FIG. 1;

FIG. 3 is an exemplary block diagram showing an example of the structure of a temperature monitoring system which is provided in the computer shown in FIG. 1;

FIG. 4 is an exemplary block diagram showing an example of the structure of an EC/KBC which is provided in the computer shown in FIG. 1;

FIG. 5 is an exemplary diagram for explaining transition of system states of the computer shown in FIG. 1;

FIG. 6 is a table showing an example of the relationship between the system states used in the computer shown in FIG. 1 and power states of respective devices;

FIG. 7 is an exemplary diagram showing an example of a temperature control process which is executed in system state S0 by the computer shown in FIG. 1;

FIG. 8 is an exemplary diagram showing an example of a temperature control process which is executed in system state S1 by the computer shown in FIG. 1;

FIG. 9 is an exemplary diagram showing an example of a functional structure of a BIOS which is used in the computer shown in FIG. 1;

FIG. 10 is an exemplary diagram showing an example of an interface between an operating system and BIOS in the computer shown in FIG. 1;

FIG. 11 is an exemplary diagram showing an example of a system setup screen which is used in the computer shown in FIG. 1;

FIG. 12 is an exemplary flow chart illustrating an example of the procedure of a suspend process which is executed by the computer shown in FIG. 1;

FIG. 13 is an exemplary flow chart illustrating an example of a temperature monitoring operation which is executed by the computer shown in FIG. 1;

FIG. 14 is an exemplary flow chart illustrating an example of a state control process which is executed by the computer shown in FIG. 1; and

FIG. 15 is an exemplary flow chart illustrating an example of the procedure of a resume/boot process which is executed by the computer shown in FIG. 1.

### DETAILED DESCRIPTION

Various embodiments according to the invention will be described hereinafter with reference to the accompanying drawings. In general, according to one embodiment of the invention, an information processing apparatus includes a main body, a system memory provided in the main body, a display controller provided in the main body, a temperature sensor provided in the main body, a first state control unit, and second state control unit. The first state control unit transitions a system state of the information processing apparatus from a working state to a first state in which the main body is powered off in a state in which power is supplied to the system memory and the display controller. The second state control unit transitions the system state from the first state to a second state in which supply of power to the display controller is stopped in a state in which supply of power to the system memory is maintained, in a case where a temperature which is detected by the temperature sensor in the first state exceeds a predetermined threshold value.

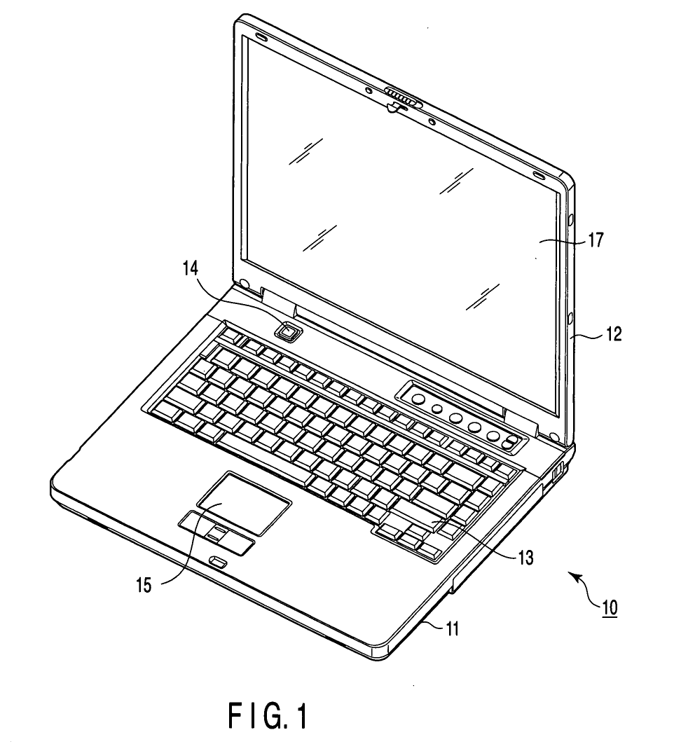

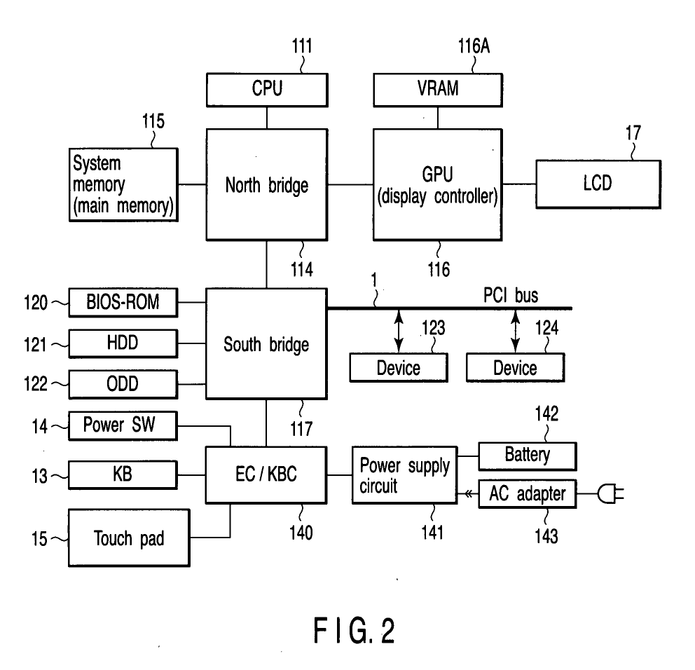

Referring to FIG. 1 and FIG. 2, the structure of an information processing apparatus according to the embodiment of the invention is described. The information processing apparatus is realized, for example, as a battery-powerable notebook-type portable personal computer 10.

FIG. 1 is a perspective view showing the computer 10 in the state in which a display unit thereof is opened. The computer 10 comprises a computer main body 11 and a display unit 12. A display device that is composed of an LCD (Liquid Crystal Display) 17 is built in the display unit 12. The display screen of the LCD 17 is positioned at an approximately central part of the display unit 12.

The display unit 12 is attached to the computer main body 11 such that the display unit 12 is freely rotatable between an open position where a top surface of the computer main body 11 is exposed and a closed position where the top surface of the main body 11 is covered by the display unit 12. The computer main body 11 has a thin box-shaped casing in which a battery can detachably be attached.

A keyboard 13, a power button switch 14 for powering on/off the computer 10 and a touch pad 15 are disposed on the top surface of the computer main body 11.

Next, referring to FIG. 2, the system configuration of the computer 10 is described.

The computer 10, as shown in FIG. 2, comprises a CPU 111, a north bridge 114, a system memory (also referred to as “main memory”) 115, a graphics processing unit (GPU) 116, a south bridge 117, a BIOS-ROM 120, a hard disk drive (HDD) 121, an optical disc drive (ODD) 122, various PCI devices 123, 124, an embedded controller/keyboard controller IC (EC/KBC) 140, and a power supply circuit 141.

The CPU 111 is a processor that is provided for controlling the operation of the computer 10. The CPU 111 executes an operating system and various application programs, which are loaded in the system memory 115 from the HDD 121.

The CPU 111 also executes a BIOS (Basic Input/Output System) that is stored in the BIOS-ROM 120. The BIOS is a program for hardware control. The BIOS also has a function of controlling the system state of the computer 10.

The north bridge 114 is a bridge device that connects a local bus of the CPU 111 and the south bridge 117. The north bridge 114 includes a memory controller that access-controls the main memory 115. The north bridge 114 has a function of executing communication with the graphics processing unit (GPU) 116 via, e.g., a PCI Express bus.

The graphics processing unit (GPU) 116 is a display controller for controlling the LCD 17 that is used as a display monitor of the computer 10. The GPU 116 generates a video signal, which forms a screen image to be displayed on the LCD 17, on the basis of display data that is written in a video memory (VRAM) 116A by the OS or application program. In addition, the GPU 116 has a rendering function which executes 2D or 3D graphics arithmetic operations in response to a rendering request from the OS or application program.

The south bridge 117 is connected to a PCI bus 1 and executes communication with the PCI devices 123 and 124 via the PCI bus 1. The south bridge 117 includes an IDE (Integrated Drive Electronics) controller or a Serial ATA controller for controlling the hard disk drive (HDD) 121 and optical disc drive (ODD) 122.

The embedded controller/keyboard controller IC (EC/KBC) 140 is a 1-chip microcomputer in which an embedded controller for power management and a keyboard controller for controlling the keyboard (KB) 13 and touch pad 15 are integrated. The EC/KBC 140 is always supplied with operation power from the power supply circuit 141 even in the state in which the computer 10 is powered off.

The EC/KBC 140 has a function of powering on/off the computer 10 in response to the user's operation of the power button switch 14. The power on/off control of the computer 10 is executed by cooperation of the EC/KBC 140 and power supply circuit 141. The power supply circuit 141 uses power from a battery 142 which is mounted in the computer main body 11 or power from an AC adapter 143 which is connected to the computer main body 11 as an external power supply, thereby generating operation powers to the respective components.

Further, the EC/KBC 140 has a function of monitoring the system temperature of the computer 10 (i.e. the temperature in the computer main body 11). The temperature monitoring operation is executed not only when the system state of the computer 10 is a working state (operation state), but also when the system state of the computer 10 is a standby state.

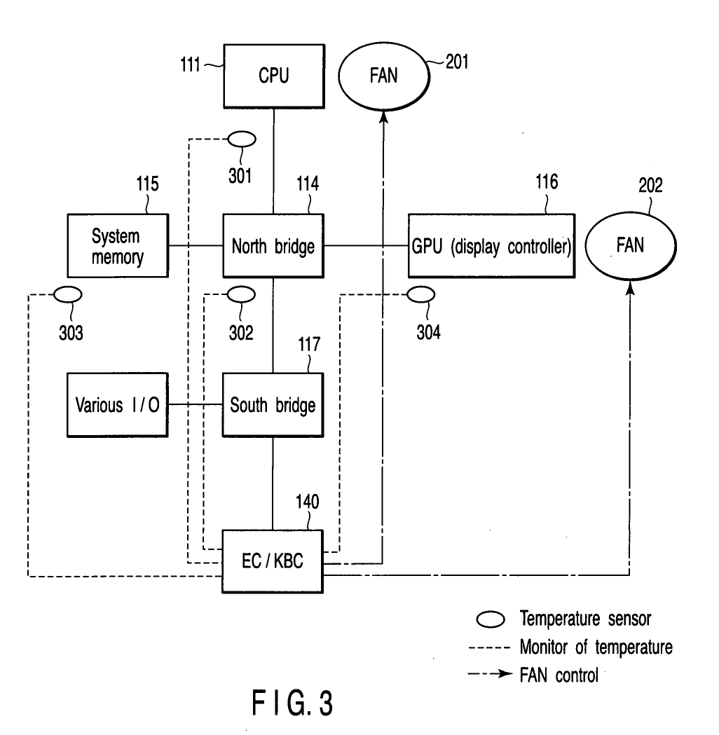

FIG. 3 shows an example of a system configuration for the temperature monitor.

In the computer main body 11, temperature sensors for detecting temperatures at predetermined positions in the computer main body 11 are provided. FIG. 3 shows an example in which four temperature sensors 301, 302, 303 and 304 are provided.

The temperature sensor 301 is a temperature sensor for detecting the temperature of the CPU 111, and is disposed on the CPU 111 or near the CPU 111. The temperature sensor 302 is a temperature sensor for detecting the temperature of the north bridge 114, and is disposed on the north bridge 114 or near the north bridge 114. The temperature sensor 303 is a temperature sensor for detecting the temperature of the system memory 115, and is disposed on the system memory 115 or near the system memory 115. The temperature sensor 304 is a temperature sensor for detecting the temperature of the GPU 116, and is disposed on the GPU 116 or near the GPU 116.

Alternatively, the temperature at a specified position, where the temperature in the computer main body 11 tends to rise relatively easily, may be monitored by a single temperature sensor.

Further, a fan is provided in the computer main body 11.

In the example shown in FIG. 3, two fans 201 and 202 are provided. The fan 201 is a cooling fan for cooling the CPU 111, and the fan 202 is a cooling fan for cooling the GPU 116.

Of the components of the system, the CPU 111 and GPU 116 are heat-producing devices which produce a relatively great quantity of heat. Thus, by cooling the CPU 111 and GPU 116 by the fan 201 and fan 202, respectively, the system temperature can be kept at a low level.

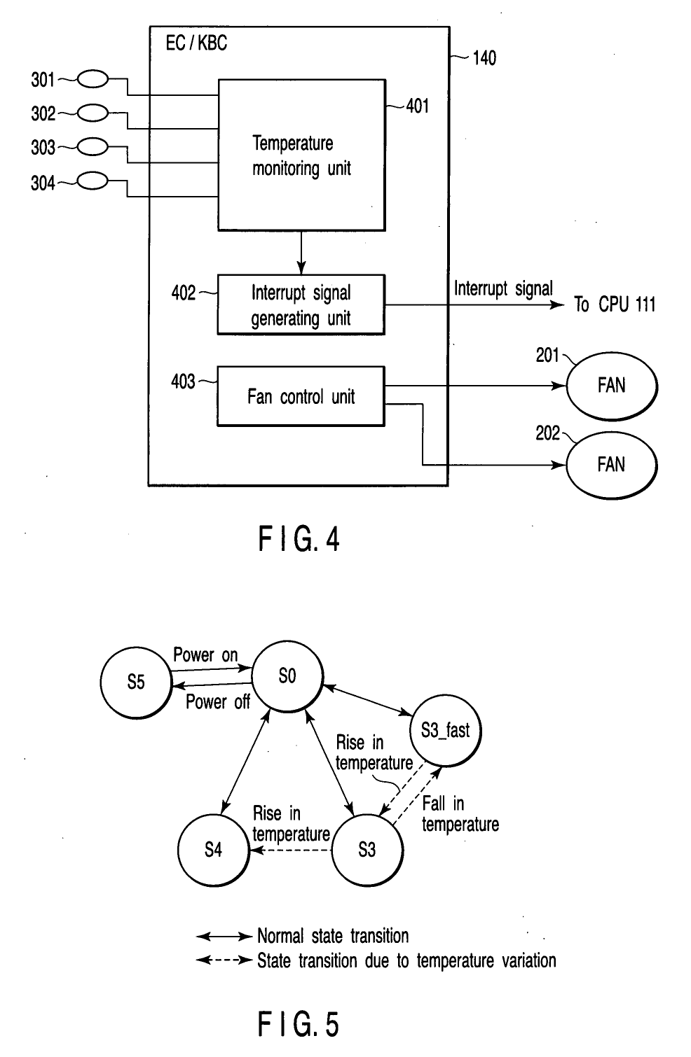

FIG. 4 shows an example of the structure of the EC/KBC 140.

The EC/KBC 140 includes a temperature monitoring unit 401, an interrupt signal generating unit 402 and a fan control unit 403.

The temperature monitoring unit 401 monitors the system temperature, that is, the temperature in the computer main body 11, by using all or arbitrary one of the temperature sensors 301 to 304. In the case where all temperature sensors 301 to 304 are used, the temperature monitoring unit 401 can monitor the temperatures of the CPU 111, north bridge 114, system memory 115 and GPU 116. Needless to say, the temperature monitoring unit 401 may monitor the temperature at a specified position in the computer main body 11 by using only specific one of the temperature sensors 301 to 304.

As has been described above, the temperature monitoring operation by the temperature monitoring unit 401 is executed not only when the system state of the computer 10 is the working state, but also when the system state is the standby state.

If the temperature monitoring unit 401 detects that the system temperature exceeds a specific threshold value, the interrupt signal generating unit 402 supplies an interrupt signal, such as a system management interrupt (SMI), to the CPU 111, thereby informing the CPU 111 of the occurrence of the temperature event that the system temperature exceeds the specific threshold value.

The fan control unit 403 controls the rotational speeds of the fans 201 and 202 under the control of the CPU 111.

Next, referring to FIG. 5, the transition of the system state of the computer 10 is described.

The system state of the computer 10 is set at any one of S0, S3_fast, S3, S4 and S5.

S0 is a working state (in which the system is powered on and the software is being executed), and S5 is an off-state (in which the system is powered off and no software is being executed).

S3_fast, S3 and S4 are used as standby states which are intermediate states between the working state S0 and off-state S5. The power consumption of the system in the standby state is less than the power consumption of the system in the working state S0.

S3 is one of sleep states which are defined by the ACPI specification. In the present embodiment, S3 is used as a standby state which is called “memory suspend state”.

In S3, i.e. the memory suspend state, almost all of the devices excluding the system memory 115 are powered off. In S3, i.e. the memory suspend state, if a wakeup event, such as a user's operation of the power button switch 14, occurs, the system state is restored from S3 to S0. Thereby, the execution of the software can be resumed from the state immediately before the transition to S3.

S4 is also one of the sleep states defined by the ACPI specification. In the present embodiment, S4 is used as a standby state which is called “hibernation state”. In S4, i.e. the hibernation state, almost all the devices including the system memory 115 are powered off in the state in which the context that is stored in the system memory 115 is saved in the HDD 121.

S3_fast is a standby state in which the system state can be restored to S0 more quickly than in the case of S3, e.g., the memory suspend state. In S3_fast, the computer main body 11, that is, the system of the computer 10, is powered off in the state in which the supply of power to the system memory 115 and GPU 116 is maintained. The context of the GPU 116 is not lost. Thus, without the need to initialize the GPU 116, the system state can be restored from S3_fast to S0. A relatively great deal of time is needed to initialize the GPU 116. By using S3_fast as the standby state, it becomes possible to greatly reduce the time that is needed for the restoration from the standby state to S0.

The relationship in time length for the restoration from S3_fast, S3 and S4 to S0 is as follows.

S3_fast<S3<S4.

The relationship in power consumption between S3_fast, S3 and S4 is as follows.

S3_fast>S3>S4.

In the computer 10, the three standby states, S3_fast, S3 and S4, are selectively usable. In the description below, S3_fast is referred to as “first standby state (first state)”, S3 as “second standby state (second state)”, and S4 as “third standby state (third state)”.

In the computer 10, the first standby state S3_fast is basically used as a default standby state. If a suspend request occurs in the working state S0, for example, due to the user's operation of the power button 14, a suspend process is executed to transition the system state from the working state S0 to the first standby state S3_fast. In the first standby state S3_fast, as described above, the computer main body 11 is powered off in the state in which power is supplied to the system memory 115 and GPU 116.

Also in the first standby state S3_fast, the EC/KBC 140 monitors the system temperature. If the system temperature exceeds a predetermined first threshold value, a state transition process is executed to transition the system state from the first standby state S3_fast to the second standby state S3. In the second standby state S3, the supply of power to the GPU 116 is stopped in the state in which the supply of power to the system memory 115 is maintained.

In the second standby state S3, since the GPU 116 is powered off, the GPU 116 produces no heat. Accordingly, by transitioning the system state from the first standby state S3_fast to the second standby state S3, the system temperature can be lowered without rotating the fan.

In the second standby state S3, if the system temperature decreases below a second threshold value, which is lower than the above-mentioned first threshold value, a process is executed to transition the system state from the second standby state S3 to the first standby state S3_fast. When the system state is transitioned from the second standby state S3 to the first standby state S3_fast, the supply of power to the GPU 116 is resumed in order to power on the GPU 116, and a process for initializing the GPU 116 is also executed.

On the other hand, in the second standby state S3, if the system temperature exceeds a third threshold value, which is higher than the first threshold value, a process is executed to transition the system state from the second standby state S3 to the third standby state S4 in which supply of power to the CPU 111, system memory 115 and GPU 116 is stopped. When the second standby state S3 is transitioned to the third standby state S4, the context stored in the system memory 115 is first saved in the HDD 121. Then, the computer main body 11 is powered off. Thereby, almost all the devices including the CPU 111, system memory 115 and GPU 116 are powered off, and the system state makes a transition to the third standby state S4.

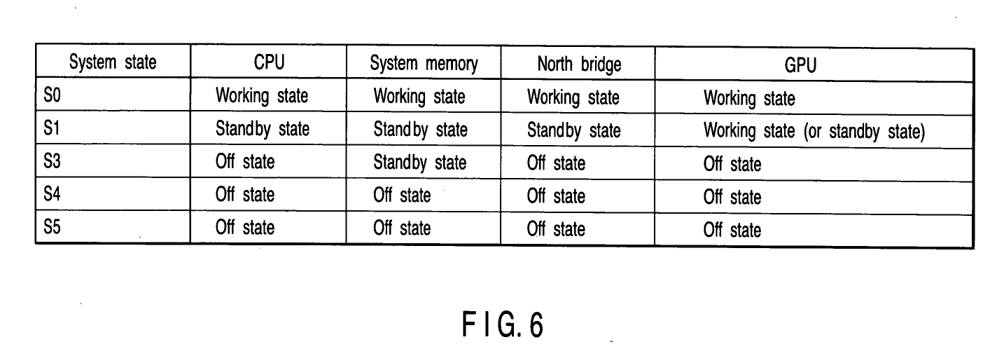

Next, referring to FIG. 6, a description is given of an example of the relationship between the system states and the power states of the CPU 111, system memory 115, north bridge 114 and GPU 116.

The CPU 111 is set in any one of the working state, standby state and off-state. In each of the working state and standby state, power is supplied to the CPU 111. In the case where the CPU 111 is in the off-state, the supply of power to the CPU 111 is stopped.

The working state of the CPU 111 is realized, for example, by using a processor state C0 which is defined by the ACPI specification. While the CPU 111 is in the working state, i.e. the processor state C0, the CPU 111 executes instructions.

The off-state of the CPU 111 is realized, for example, by using a processor state C5 which is defined by the ACPI specification. While the CPU 111 is in the off-state, i.e. the processor state C5, supply of power to the CPU 111 is stopped.

The standby state of the CPU 111 is an intermediate state between the working state (C0) and off-state (C5), and is realized, for example, by using a processor state C1, C2, C3 or C4, which is defined by the ACPI specification. The power consumption of the CPU 111 in the standby state is less than the power consumption of the CPU 111 in the working state (C0).

The relationship in power consumption between the processor states C1, C2, C3, C4 and C5, and the relationship in time length for the restoration from the processor states C1, C2, C3, C4 and C5 to C0 are as follows.

Power consumption: C1>C2>C3>C4>C5

Time for restoration: C1<C2<C3<C4<C5.

The system memory 115 is set in any one of the working state, standby state and off-state. In each of the working state and standby state, power is supplied to the system memory 115. In the case where the system memory 115 is in the off-state, supply of power to the system memory 115 is stopped. While the system memory 115 is in the standby state, only a self-refresh operation is executed in order to prevent loss of the context stored in the system memory 115. Access from the outside to the system memory 115 is not executed. The power consumption of the system memory 115 in the standby state is less than the power consumption of the system memory 115 in the working state.

The north bridge 114 is set in any one of the working state, standby state and off-state. In each of the working state and standby state, power is supplied to the north bridge 114. In the case where the north bridge 114 is in the off-state, supply of power to the north bridge 114 is stopped.

The working state of the north bridge 114 is realized, for example, by using a device state D0 which is defined by the ACPI specification. While the north bridge 114 is in the working state, i.e. the device state D0, the north bridge 114 is fully active.

The off-state state of the north bridge 114 is realized, for example, by using a device state D3 which is defined by the ACPI specification. While the north bridge 114 is in the off-state, i.e. the device state D3, supply of power to the north bridge 114 is stopped.

The standby state of the north bridge 114 is an intermediate state between the working state (D0) and off-state (D3), and is realized, for example, by using a device state D1 or D2, which is defined by the ACPI specification. The power consumption of the north bridge 114 in the standby state (D1 or D2) is less than the power consumption of the north bridge 114 in the working state (D0).

The relationship in power consumption of the north bridge 114 between the device states D1, D2 and D3, and the relationship in time length for the restoration of the north bridge 114 from the device states D1, D2 and D3 to D0 are as follows:

Power consumption: D1>D2>D3

Time for restoration: D1<D2<D3.

The GPU 116 is set in any one of the working state, standby state and off-state. In each of the working state and standby state, power is supplied to the GPU 116. In the case where the GPU 116 is in the off-state, supply of power to the GPU 116 is stopped.

The working state of the GPU 116 is realized, for example, by using a device state D0 which is defined by the ACPI specification. While the GPU 116 is in the working state, i.e. the device state D0, the GPU 116 is fully active.

The off-state state of the GPU 116 is realized, for example, by using a device state D3 which is defined by the ACPI specification. While the GPU 116 is in the off-state, i.e. the device state D3, supply of power to the GPU 116 is stopped.

The standby state of the GPU 116 is an intermediate state between the working state (D0) and off-state (D3), and is realized, for example, by using a device state D1 or D2, which is defined by the ACPI specification. The power consumption of the GPU 116 in the standby state (D1 or D2) is less than the power consumption of the GPU 116 in the working state (D0).

The relationship in power consumption of the GPU 116 between the device states D1, D2 and D3, and the relationship in time length for the restoration of the GPU 116 from the device states D1, D2 and D3 to D0 are as follows:

Power consumption: D1>D2>D3

Time for restoration: D1<D2<D3.

In the case where the system state is the working state S0, for example, the CPU 111 is in the working state (C0), the system memory 115 is in the working state, the north bridge 114 is in the working state (D0) and the GPU 116 is in the working state (D0).

In the case where the system state is the first standby state (S3_fast), i.e. S1, for example, the CPU 111 is in the standby state (C1, C2, C3 or C4), the system memory 115 is in the standby state, the north bridge 114 is in the standby state (D1 or D2) and the GPU 116 is in the working state (D0) or in the standby state (D1 or D2).

In the case where the system state is the second standby state (S3), for example, the CPU 111 is in the off-state (C5), the system memory 115 is in the standby state, the north bridge 114 is in the off-state (D3) and the GPU 116 is in the off-state (D3).

In the case where the system state is the third standby state (S4), all of the CPU 111, system memory 115, north bridge 114 and GPU 116 are in the off-state. However, the context is maintained in the HDD 121.

In the case where the system state is the off-state (S5), all of the CPU 111, system memory 115, north bridge 114 and GPU 116 are in the off-state. The context is lost.

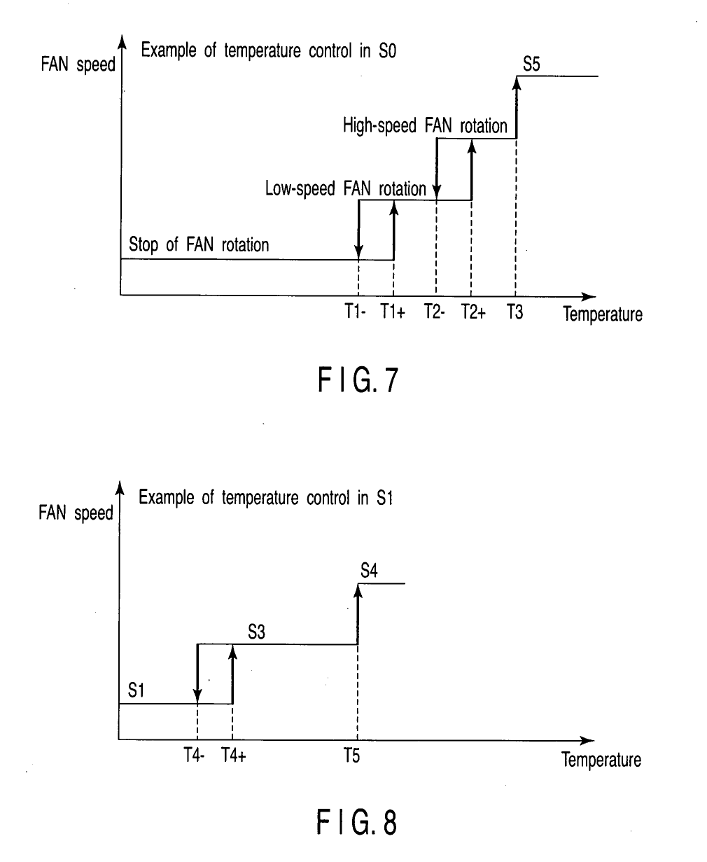

Next, referring to FIG. 7, a description is given of a temperature control process which is executed by the BIOS in the case where the system state is S0. Assume now that the number of temperature sensors is one, the number of fans is one, and the fan rotation speed is controlled stepwise in two stages.

If the temperature that is detected by the temperature sensor exceeds a threshold value T1+, the BIOS controls the fan 201 or 202 via the fan control unit 403 of the EC/KBC 140, thereby rotating the fan 201 or 202 at a predetermined low number of revolutions. If the temperature that is detected by the temperature sensor lowers to a threshold value T1− or less, the BIOS controls the fan 201 or 202 via the fan control unit 403 of the EC/KBC 140, thereby stopping the rotation of the fan 201 or 202.

If the temperature that is detected by the temperature sensor exceeds a threshold value T2+, the BIOS controls the fan 201 or 202 via the fan control unit 403 of the EC/KBC 140, thereby rotating the fan 201 or 202 at a predetermined high number of revolutions. If the temperature that is detected by the temperature sensor lowers to a threshold value T2- or less, the BIOS controls the fan 201 or 202 via the fan control unit 403 of the EC/KBC 140, thereby decreasing the number of revolutions of the fan 201 or 202 to the above-mentioned low number of revolutions.

If the temperature that is detected by the temperature sensor exceeds a threshold value T3, the BIOS transitions the system state from S0 to S5 and stops the operations of all devices in order to secure the safety of the system.

This fan control process is executed only when the system state is S0, and is not executed in the standby state S1, S3 or S4.

Next, referring to FIG. 8, a description is given of a temperature control process which is executed in the standby state S1 or S3.

In the first standby state S1 (=S3_fast), if the temperature that is detected by the temperature sensor exceeds a threshold value T4+, the BIOS executes a state control process for transitioning the system state from the first standby state S1 (=S3_fast) to the second standby state S3.

In the second standby state S3, if the temperature that is detected by the temperature sensor lowers to a threshold value T4− or less, the BIOS executes a state control process for transitioning the system state from the second standby state S3 to the first standby state S1 (=S3_fast). The threshold value T4− is set to be lower than the threshold value T4+.

In the second standby state S3, if the temperature that is detected by the temperature sensor exceeds a threshold value T5, the BIOS executes a state control process for transitioning the system state from the second standby state S3 to the third standby state S4. The threshold value T5 is set to be higher than the threshold value T4+.

The threshold values T4+ and T4− are set to be lower than the threshold values T1+ and T1− in FIG. 7. Thereby, the system temperature in the standby state S1 or S3 can be kept lower than the system temperature in the working state S0.

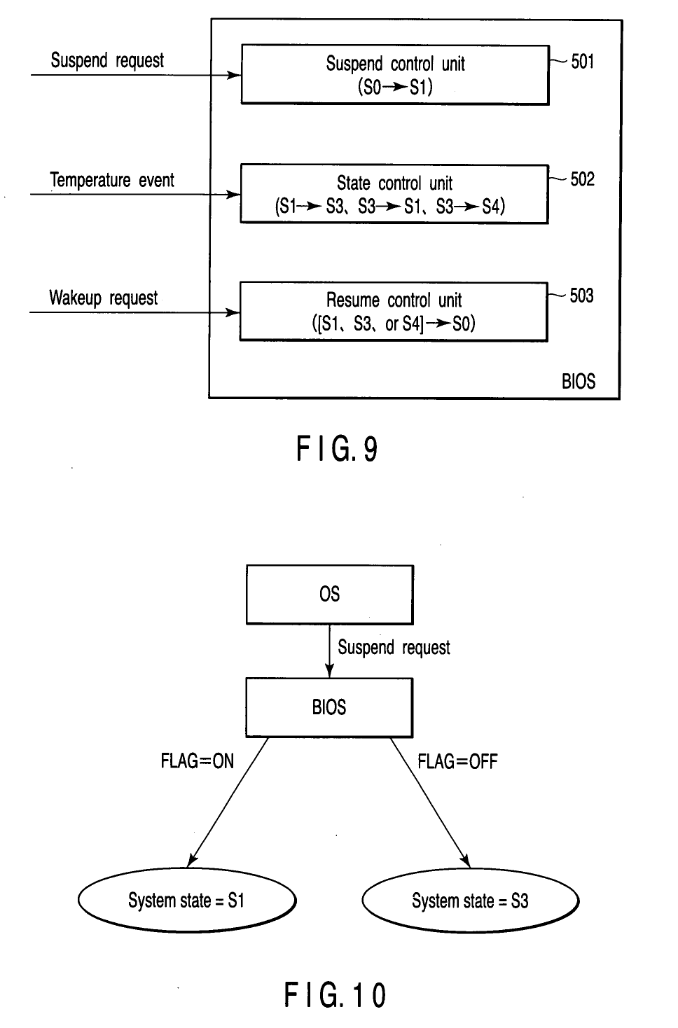

Next, the functional structure of the BIOS is explained with reference to FIG. 9.

The BIOS includes, as its function executing modules, a suspend control unit 501, a state control unit 502 and a resume control unit 503.

The suspend control unit 501 functions as a state control unit and executes a suspend process for transitioning the system state from the working state S0 to the first standby state S1 (=S3_fast), in response to occurrence of a suspend request which requests transition from the working state S0 to the standby state.

Responding to occurrence of a temperature event, the state control unit 502 executes a process for transitioning the system state from the first standby state S1 (=S3_fast) to the second standby state S3, a process for transitioning the system state from the second standby state S3 to the first standby state S1 (=S3_fast), or a process for transitioning the system state from the second standby state S3 to the third standby state S4. Specifically, the state control unit 502 functions as a state control unit which transitions the system state from the first standby state S1 (=S3_fast) to the second standby state S3 when the temperature that is detected by the temperature sensor in the first standby state S1 (=S3_fast) exceeds a predetermined threshold value, and as a state control unit which transitions the system state from the second standby state S3 to the first standby state S1 (=S3_fast) when the temperature that is detected by the temperature sensor in the second standby state S3 lowers to a threshold value or less, which is lower than the above-mentioned predetermined threshold value. Further, the state control unit 502 functions as a state control unit (hibernation control unit) which saves the context stored in the system memory 115 into the HDD 121 and transitions the system state from the second standby state S3 to the third standby state S4 when the temperature that is detected by the temperature sensor in the second standby state S3 exceeds a threshold value that is higher than the above-mentioned predetermined threshold value.

The resume control unit 503 executes, in response to occurrence of a wakeup request, a resume process for transitioning the system state from S1, S3 or S4 to S0 and resuming the system operation.

The functions of the suspend control unit 501, state control unit 502 and resume control unit 503 may also be realized by hardware such as the EC/KBC 140.

FIG. 10 shows an example of the interface between the operating system (OS) and BIOS.

From the viewpoint of the OS, both the first standby state S1 (=S3_fast) and the second standby state S3 are the same memory suspend state.

The user of the computer 10 designates, in advance, which of the first standby state S1 (=S3_fast) and second standby state S3 is to be used as the memory suspend state.

If a flag indicative of the use of the first standby state S1 (=S3_fast) is “on”, the BIOS selects, upon receiving the suspend request from the OS, the first standby state S1 (=S3_fast) as the memory suspend state, and transitions the system state to the first standby state S1 (=S3_fast).

On the other hand, if the flag indicative of the use of the first standby state S1 (=S3_fast) is “off”, the BIOS selects, upon receiving the suspend request from the OS, the second standby state S3 as the memory suspend state, and transitions the system state to the second standby state S3.

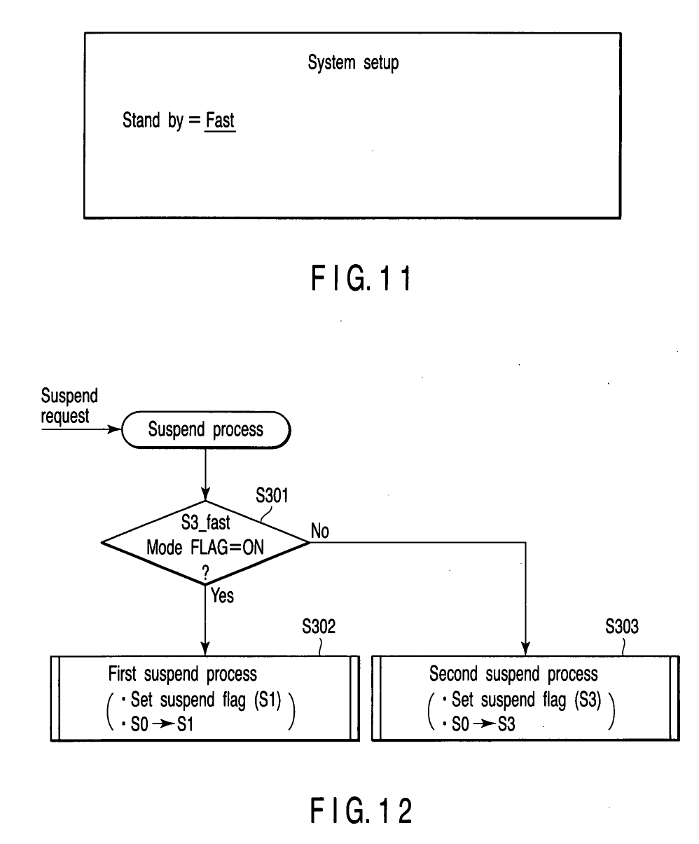

FIG. 11 shows an example of a setup screen for prompting the user to designate the memory suspend state.

The setup screen shown in FIG. 11 is displayed on the LCD 17 by the BIOS when the user performs a predetermined key input operation before the OS is booted up. If the item “Standby” is set to “Fast” on the system setup screen, the first standby state S1 (=S3_fast) is selected as the memory suspend state. On the other hand, if the item “Standby” is set to “Normal”, the second standby state S3 is selected as the memory suspend state.

The BIOS stores the flag (hereinafter referred to as “S3_fast mode flag”), which is indicative of whether the first standby state S1 (=S3_fast) is effective or not, in a nonvolatile memory such as the BIOS-ROM 120.

Next, referring to a flow chart of FIG. 12, the procedure of the suspend process which is executed by the BIOS is described.

Upon receiving a suspend request from the OS, the BIOS first refers to the S3_fast mode flag and determines whether the first standby state S1 (=S3_fast) is effective or not (block S301).

If the S3_fast mode flag is “on”, that is, if the first standby state S1 (=S3_fast) is effective (YES in block S301), the BIOS executes a first suspend process for setting the system state to the first standby state S1 (=S3_fast) (block S302).

In the first suspend process, the BIOS executes a process of setting the suspend flag indicative of the first standby state S1 in, e.g., a register in the EC/KBC 140, and a process of transitioning the system state from the working state S0 to the first standby state S1 (=S3_fast).

In this transitioning process, the BIOS executes, in cooperation with the EC/KBC 140, a process of powering off the computer main body 11 in the state in which power is being supplied to at least the system memory 115 and GPU 116. Specifically, the BIOS powers off the computer main body 11 while keeping power supply to the CPU 111, system memory 115, north bridge 114 and GPU 116. The BIOS also executes a process of setting the CPU 111 in the processor state C1, C2, C3 or C4, a process of setting the system memory 115 in the standby state, a process of setting the north bridge 114 in the device state D1 or D2, and a process of setting the GPU 116 in the device state D1 or D2. In the case where D0 is used as the state of the GPU 116 in the first standby state S1 (=S3_fast), the process of setting the GPU 116 in the device state D1 or D2 is omitted.

If the S3_fast mode flag is “off”, that is, if the first standby state S1 (=S3_fast) is non-effective (NO in block S301), the BIOS executes a second suspend process for setting the system state to the second standby state S3 (block S303).

In the second suspend process, the BIOS executes a process of setting the suspend flag indicative of the second standby state S3 in, e.g., the register in the EC/KBC 140, and a process of transitioning the system state from the working state S0 to the second standby state S3.

In this transitioning process, the BIOS executes, in cooperation with the EC/KBC 140, a process of saving the context of the system (e.g., content of the register in the CPU 111) in the system memory 115 and then powering off the computer main body 11 in the state in which the supply of power to the system memory 115 is maintained.

In each of the first standby state S1 (=S3_fast) and second standby state S3, the context stored in the system memory 115 is not lost. Thus, by using the context stored in the system memory 115, the system can be restored to the working state immediately before the occurrence of the suspend request.

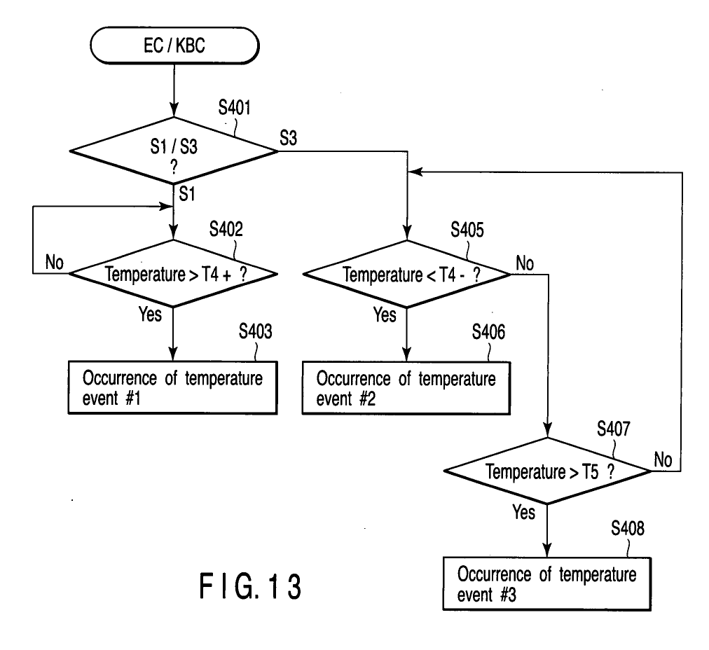

Next, referring to a flow chart of FIG. 13, a description is given of the temperature monitoring operation which is executed by the EC/KBC 140 in the first standby state S1 (=S3_fast) or second standby state S3.

The EC/KBC 140 refers to the above-described suspend flag and determines whether the current system state is the first standby state S1 (=S3_fast) or second standby state S3 (block S401).

While the system is in the first standby state S1 (=S3_fast), the EC/KBC 140 monitors the temperature that is detected by the temperature sensor and determines whether the detected temperature exceeds the threshold value T4+(block S402).

When the detected temperature exceeds the threshold value T4+(YES in block S402), the EC/KBC 140 delivers an interrupt signal, such as a system management interrupt (SMI), to the CPU 111, and informs the CPU 111 of the occurrence of a temperature event #1 which indicates that the system temperature exceeds the threshold value T4+(block S403). Responding to the interrupt signal, the CPU 111 wakes up and temporarily transitions to C0. The CPU 111 then executes the BIOS.

If the temperature event #1 occurs, the system state is transitioned to the second standby state S3 by the BIOS.

While the system is in the second standby state S3, the EC/KBC 140 monitors the temperature that is detected by the temperature sensor, and executes a process of determining whether the detected temperature lowers to the threshold value T4- or less (block S405) and a process of determining whether the detected temperature exceeds the threshold value T5 (block S407).

When the detected temperature lowers to the threshold value T4- or less (YES in block S405), the EC/KBC 140 resumes supply of power to the CPU 111, delivers an interrupt signal, such as a system management interrupt (SMI), to the CPU 111, and informs the CPU 111 of the occurrence of a temperature event #2 which indicates that the system temperature lowers to the threshold value T4- or less (block S406).

When the detected temperature exceeds the threshold value T5 (YES in block S407), the EC/KBC 140 resumes the supply of power to the CPU 111, delivers an interrupt signal, such as a system management interrupt (SMI), to the CPU 111, and informs the CPU 111 of the occurrence of a temperature event #3 which indicates that the system temperature exceeds the threshold value T5 (block S408).

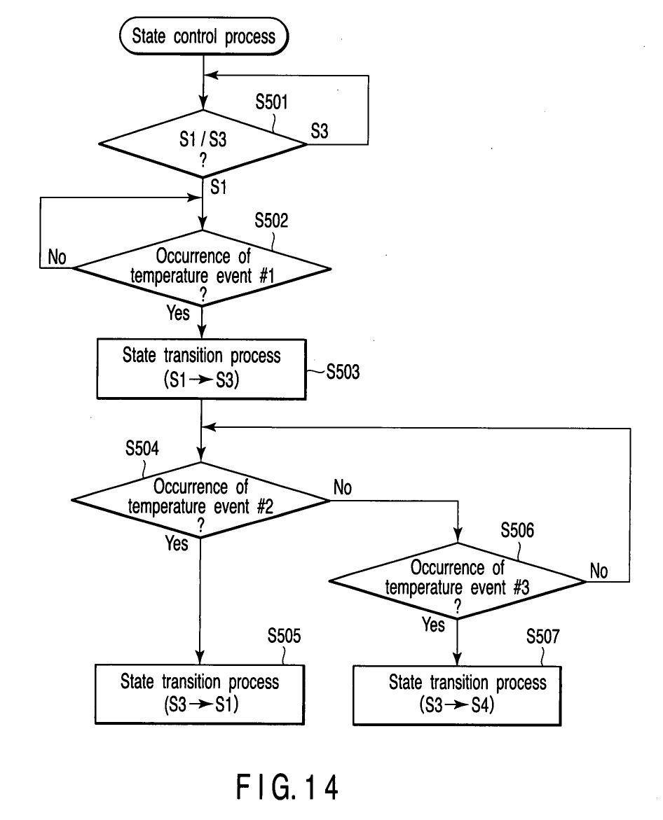

Next, referring to a flow chart of FIG. 14, a description is given of the procedure of the state control process which is executed by the BIOS while the system state is the standby state.

If the CPU 111 temporarily wakes up upon receiving the interrupt signal, the BIOS determines whether the current standby state is the first standby state S1 (=S3_fast) or the second standby state S3 (block S501).

If the current standby state is the first standby state S1 (=S3_fast), the BIOS refers to, e.g., the status register of the EC/KBC 140 and determines whether the cause of the occurrence of the interrupt signal is the occurrence of the temperature event #1, that is, whether the temperature event #1 has occurred in the first standby state S1 (=S3_fast) (block S502).

If the temperature event #1 has occurred, the BIOS transitions the system state from the first standby state S1 (=S3_fast) to the second standby state S3 (block S503). In block S503, the supply of power to the CPU 111, north bridge 114 and GPU 116 is stopped in the state in which the supply of power to the system memory 115 is maintained.

If the CPU 111 temporarily wakes up upon receiving the interrupt signal in the second standby state S3, the BIOS refers to, e.g., the status register of the EC/KBC 140, and determines which of the temperature event #2 and temperature event #3 has occurred (block S504, S505).

If the temperature event #2 has occurred in the second standby state S3 (YES in block S504), the BIOS transitions the system state from the second standby state S3 to the first standby state S1 (=S3_fast) (block S505). In block S505, supply of power to the CPU 111, north bridge 114 and GPU 116 is resumed. In addition, the BIOS executes the process for initializing the GPU 116.

If the temperature event #3 has occurred in the second standby state S3 (YES in block S506), the BIOS transitions the system state from the second standby state S3 to the third standby state S4 (block S507). In block S507, the BIOS saves the context, which is stored in the system memory 115, in the HDD 121, and stops supply of power to almost all devices including the system memory 115.

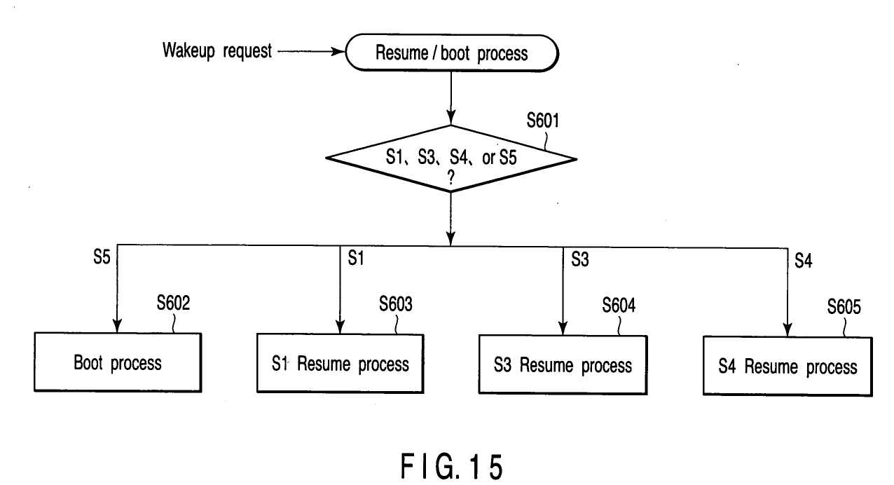

Next, referring to a flow chart of FIG. 15, the procedure of a resume/boot process, which is executed by the BIOS, is described.

When a wakeup request, for example, by the user's operation of the power button switch 14, has occurred, the computer 10 is powered on and the BIOS determines whether the current system state is the first standby state S1 (=S3_fast), second standby state S3, third standby state S4, or off-state S5 (block S601).

If the current system state is the off-state S5, the BIOS executes a process of booting up the operating system (block S602).

If the current system state is the first standby state S1 (=S3_fast), the BIOS executes a first resume process for transitioning the system state from the first standby state S1 to the working state S0 (block S603). While the system state is in the first standby state S1 (=S3_fast), the GPU 116 is kept in the power-on state. Thus, the system can quickly be restored to the working state S0 without the need to initialize the GPU 116.

If the current system state is the second standby state S3, the BIOS executes a second resume process for transitioning the system state from the second standby state S3 to the working state S0 (block S604). While the system state is in the second standby state S3, the GPU 116 is in the power-off state. Thus, in order to restore the system to the working state S0, it is necessary to execute, for example, a process of initializing the GPU 116.

If the current system state is the third standby state S4, the BIOS executes a third resume process for transitioning the system state from the third standby state S4 to the working state S0 (block S605).

As has been described above, in the present embodiment, the first standby state S1 (=S3_fast), which enables quick restoration to the working state S0, is used as the standby state. If the system temperature rises in the first standby state S1 (=S3_fast), the system state is automatically transitioned to the second standby state S3 in which the amount of heat produced is less than in the first standby state S1 (=S3_fast). Therefore, while the system temperature in the standby state is kept at a relatively low level, the system state can quickly be restored from the standby state to the working state.

In the case where the working state (D0) is used as the device state of the GPU 116 in the first standby state S1 (=S3_fast), it should suffice to monitor the temperature of only the GPU 116. The reason is that the other devices are in the standby state or off-state and the GPU 116 produces a greatest amount of heat.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
a system memory provided in the main body;
a display controller provided in the main body;
a temperature sensor provided in the main body;
a first state control unit which transitions a system state of the information processing apparatus from a working state to a first state in which the main body is powered off in a state in which power is supplied to the system memory and the display controller; and
a second state control unit which transitions the system state from the first state to a second state in which supply of power to the display controller is stopped in a state in which supply of power to the system memory is maintained, in a case where a temperature which is detected by the temperature sensor in the first state exceeds a predetermined threshold value.

2. The information processing apparatus according to claim 1, further comprising a third state control unit which transitions the system state from the second state to the first state, in a case where the temperature which is detected by the temperature sensor in the second state lowers to a threshold value or less, which is lower than the predetermined threshold value.

3. The information processing apparatus according to claim 1, further comprising a fourth state control unit which executes a process for restoring the system state from one of the first state and the second state to the working state.

4. The information processing apparatus according to claim 1, further comprising a processor which is provided in the main body, wherein supply of power to the processor is maintained in the first state and supply of power to the processor is stopped in the second state.

5. The information processing apparatus according to claim 1, further comprising:
a processor which is provided in the main body; and
a fifth state control unit which saves a context, which is stored in the system memory, into a disk storage device provided in the main body in a case where the temperature detected by the temperature sensor in the second state exceeds a threshold value which is higher than the predetermined threshold value, and transitions the system state from the second state to a third state in which supply of power to the processor, the system memory and the display controller is stopped.

6. An information processing apparatus comprising:
a main body;
a processor provided in the main body;
a system memory provided in the main body;
a display controller provided in the main body;
a temperature sensor provided in the main body;
a suspend control unit which executes a suspend process for transitioning a system state of the information processing apparatus from a working state to a first state in which the main body is powered off in a state in which power is supplied to the processor, the system memory and the display controller;
a state control unit which transitions the system state from the first state to a second state in which supply of power to the processor and the display controller is stopped in a state in which supply of power to the system memory is maintained, in a case where a temperature which is detected by the temperature sensor in the first state exceeds a predetermined threshold value; and
a resume control unit which executes a resume process for restoring the system state of the information processing apparatus from one of the first state and the second state to the working state.

7. The information processing apparatus according to claim 6, wherein the state control unit includes a unit which transitions the system state from the second state to the first state, in a case where the temperature which is detected by the temperature sensor in the second state lowers to a threshold value or less, which is lower than the predetermined threshold value.

8. The information processing apparatus according to claim 6, further comprising a hibernation control unit which saves a context, which is stored in the system memory, into a disk storage device provided in the main body in a case where the temperature detected by the temperature sensor in the second state exceeds a threshold value which is higher than the predetermined threshold value, and transitions the system state from the second state to a third state in which supply of power to the processor, the system memory and the display controller is stopped.

9. A system state control method for controlling a system state of an information processing apparatus, comprising:
transitioning the system state from a working state to a first state in which the information processing apparatus is powered off in a state in which power is supplied to a system memory and a display controller which are provided in the information processing apparatus; and
transitioning the system state from the first state to a second state in which supply of power to the display controller is stopped in a state in which supply of power to the system memory is maintained, in a case where a temperature which is detected by a temperature sensor provided in the information processing apparatus in the first state exceeds a predetermined threshold value.

10. The system state control method according to claim 9, further comprising transitioning the system state from the second state to the first state in a case where the temperature which is detected by the temperature sensor in the second state lowers to a threshold value or less, which is lower than the predetermined threshold value.

11. The system state control method according to claim 9, further comprising restoring the system state from one of the first state and the second state to the working state.

12. The system state control method according to claim 9, wherein supply of power to a processor provided in the information processing apparatus is maintained in the first state and the supply of power to the processor is stopped in the second state.

13. The system state control method according to claim 9, further comprising saving a context, which is stored in the system memory, into a disk storage device provided in the main body in a case where the temperature detected by the temperature sensor in the second state exceeds a threshold value which is higher than the predetermined threshold value, and transitioning the system state from the second state to a third state in which supply of power to a processor provided in the information processing apparatus, the system memory and the display controller is stopped.
